(19) United States
(12) Patent Application Publication
(10) Pub. No.: US 2005/0212701 A1
(43) Pub. Date: Sep. 29, 2005

(54) Skier information system

(76) Inventor: Stewart Nimmo, Lions Bay (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 11/056,143

(22) Filed: Feb. 14, 2005

Related U.S. Application Data
(60) Provisional application No. 60/543,936, filed on Feb. 13, 2004.
(60) Provisional application No. 60/621,046, filed on Oct. 25, 2004.

(51) Int. Cl. G01S 1/00

(52) U.S. Cl. 342/357.07

(57) ABSTRACT

A skier information system provides skiers with portable devices in wireless communication with a server computer system. The portable devices send location information to the server computer system. The server computer system tracks information such as t he vertical elevation skied by a skier and the runs taken by the skier.

### CROSS-REFERENCE TO RELATED APPLICATIONS

This application claims the benefit of prior U.S. application No. 60/543,936 filed on 13 Feb. 2004 and U.S. application 60/621,046 filed on 25 Oct. 2004.

### TECHNICAL FIELD

This application relates to systems for monitoring the activities of skiers at ski resorts.

### BACKGROUND

Ski resorts can be large. A person skiing at a ski resort may have difficulty locating friends from whom they have become separated or determining where various facilities are relative to his or her current location. These problems are compounded because one can often choose between many alternative routes to get from one place to another at a large ski resort. Some routes may not be advisable for those of some levels of skiing ability.

Some skiers are interested in keeping track of information such as where they have skied during the day, how many vertical feet they have skied and so on.

### BRIEF DESCRIPTION OF THE DRAWINGS

In drawings which illustrate non-limiting embodiments of the invention:

FIG. 1 is a schematic overview of a system according to the invention;

FIG. 2 is a block diagram of a portable unit which may be used in the invention;

FIG. 3 is a diagram representing a situation wherein determination of a skier's path requires resolving an ambiguity;

FIG. 4 is an example of a portion of a ski areas showing some polygons;

FIG. 5 is a view of the same ski area of FIG. 4 showing a lift polygon;

FIG. 6 is a partial routing table for the ski area of FIGS. 4 and 5;

FIG. 7 illustrates one method for determining total elevation descended according to an embodiment of the invention;

FIG. 8 illustrates a table which may be used in a system for providing information regarding nearest facilities; and,

FIG. 8A illustrates an alternative table which includes route information and may be used in a system for providing information regarding nearest facilities.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

This invention provides systems which determine the locations of skiers in a ski area. The systems use the locations to provide information of various types to the skiers while they are skiing and/or to compile information and statistics for other uses. Some embodiments of the invention provide one or more of the following functions:
indicate to a skier where another skier is currently located;
indicate to a skier where certain facilities are relative to the skier's current location;
determine which of a number of closely adjacent ski runs the skier is on;
determine when the skier is riding a chairlift;
prepare a map indicating the ski runs that the skier has skied down during a period of time; and,
keep statistics about the number of vertical feet a skier has skied, the number of runs made, the speeds achieved, and the like.

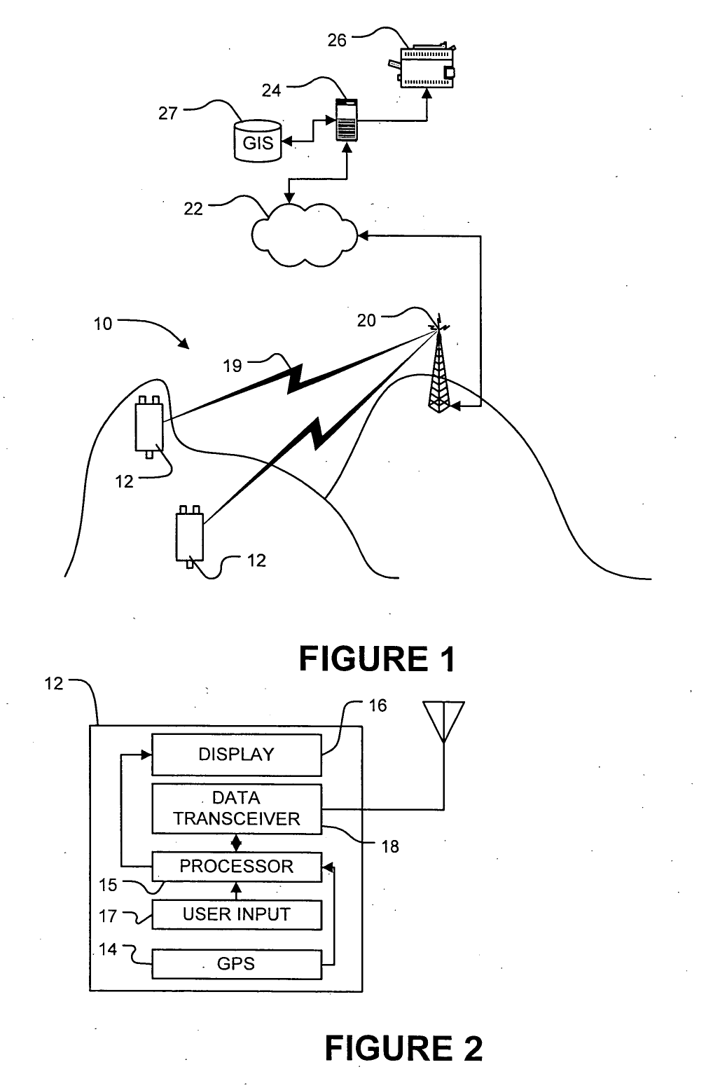

FIG. 1 shows the overall configuration of a system 10 according to the invention. System 10 includes a plurality of portable units 12 which can each be carried by a skier. As shown in FIG. 2, portable units 12 include global positioning system (“GPS”) units 14 and have data transmission capabilities. In the illustrated embodiment, each portable unit 12 comprises a processor 15 which controls a display 16, and receives input from a user input 17 and GPS system 14. Processor 15 can send or receive data by way of a wireless link 19 (FIG. 1) which portable unit 12 accesses by way of transceiver 18. Portable units 12 may comprise GPS-enabled cellular telephones, for example.

Portable units 12 are configured to periodically provide information about a current location determined by GPS unit 14 to a server computer 24. In the illustrated embodiment, portable units 12 communicate data by way of a cellular telephone system 20 and a computer network 22 (which could be provided in whole or in part by the internet). The communicated information may, for example, comprise a short message which indicates latitude and longitude, as measured by GPS unit 14, a time at which the measurement was made and a device ID corresponding to the particular portable unit 12 from which the signal originated.

Elevation information may optionally be transmitted by portable device 12. In the alternative, if elevation information is required, a digital elevation model of the ski area may be used to provide elevation information corresponding to any longitude/latitude coordinates within the area covered by the digital elevation model.

System 10 may associate the device ID of a particular portable unit 12 with a particular skier. Information about the skier may be stored in a skier profile. The skier profile may, for example, comprise a database record or set of database records. The skier profile may include information such as the skier's name, contact information, billing information, skiing ability level and the like.

Over the course of a day, server 24 thereby acquires periodic information regarding the locations of each of a plurality of skiers. The precise mechanism that triggers location information being provided to server 24 is not particularly important to the invention. For example, each portable unit 24 could include a clock and could be configured to automatically provide location information to server 24 periodically, for example once per minute or once every few seconds. It is also possible that server 24 could periodically query each portable unit 12 although this would likely result in more data traffic.

In general, the location of each portable unit 12 may be captured by server 24 as frequently as is reasonably practical. The frequency will be determined by factors such as the capacity of cellular telephone system 20, the cost of transmitting data to server 24, the battery capacity of portable unit 12 and so on. Portable unit 12 may be configured to create a set of location data more frequently than the location data is sent to server 26.

Data communication may not be feasible in some areas within a ski resort. In such cases, remote unit 12 may store several sets of location information and transmit all of the sets (or a selected group of the sets) when data communication is reestablished. In the alternative, portable unit 10 may simply keep trying to establish data communication with server 26 via link 19. In some embodiments, portable units 12 are configured to attempt to communicate to server 26 with an increased frequency if one attempt at communication fails.

One embodiment of the invention creates a map illustrating the ski runs that a skier has skied on during the course of a day or some other period. This embodiment is described below because it illustrates a number of features that may be incorporated in systems according to the invention. These features may also be applied in other contexts.

In this embodiment of the invention, server 24 determines from the location information for a skier what ski runs the skier has skied on. Server 24 may accomplish this by comparing the skier's location information to a geographical information system (“GIS”) database which includes information about the geographical extent of various ski runs. How this is done in some specific embodiments of the invention is described in more detail below.

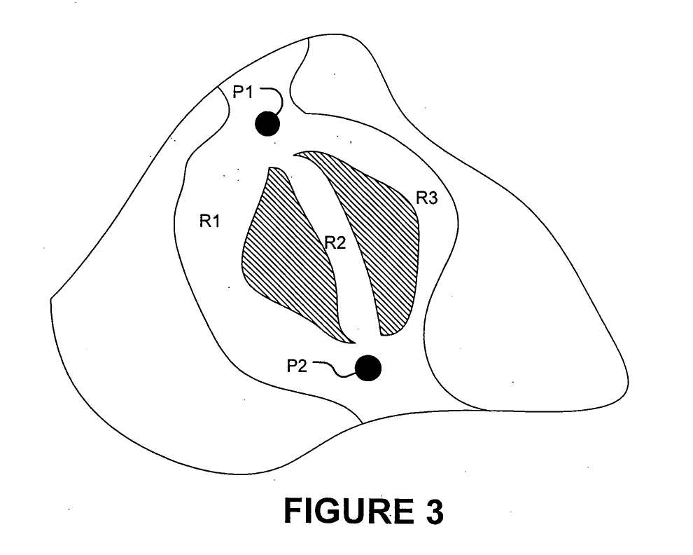

In some embodiments of the invention, the location information for each skier is provided at times which are spaced far enough apart that there could be ambiguities in determining the path actually taken by a skier. That is, the location information could be consistent with the skier having taken any one of two or more paths. Consider, for example, the situation shown in FIG. 3. At a first time T1 a skier's location is reported as being at point P1. At a next time T2, the skier's location is reported as being at point P2. It is not clear which of three ski runs R1, R2 and R3 the skier has taken to get from P1 to P2.

In such a case, system 10 may use rules to determine which of the possible runs were most likely taken by the skier. The rules may be based upon stored information regarding the difficulty of the runs and the ability of the skier; information regarding whether the runs are closed or not and the like. For example, if any of runs R1, R2 and R3 is closed then system 10 may be configured to assume that the skier did not take that run. If there remains ambiguity after eliminating any closed runs then system 10 may identify the run having a difficulty which most closely matches the skier's ability, as specified in the skier's skier profile, as the run most likely to have been taken by the skier.

Identifying a path taken by a skier permits estimation of the skier's location at any time between known GPS locations. Depending on the frequency at which a skier's location is determined and the speed at which the skier is traveling, the distances between known locations (e.g. points P1 and P2) can vary dramatically. The ski runs that a skier could possibly have taken in traveling from P1 to P2 can be determined from the two known locations and from information in a GIS database which includes information specifying a network of one or more ski runs that connect the two locations. The possible path taken by the skier can be determined by the use of either pre-built routing tables or by using a topologically-connected linear network that determines the possible linear connectivity on the-fly.

In some embodiments of the invention each ski run is associated with a defined geographical area in a GIS database. The area is typically defined as a generalized polygon. Information defining each polygon may be stored in a GIS database 27. Any suitable GIS system may be used. A number of suitable GIS systems are commercially available.

The ski run polygons represent the boundary of a ski run (e.g. the top, sides and end). A long ski run may be defined by several polygons which connect end-to-end. Each polygon has a unique id-code and a number of attributes. In a prototype embodiment of the invention the attributes of each polygon include:
run name;
alias;
run difficulty;
supporting lift; and,
status (e.g. “open”, “marginal skiing” or “closed”).

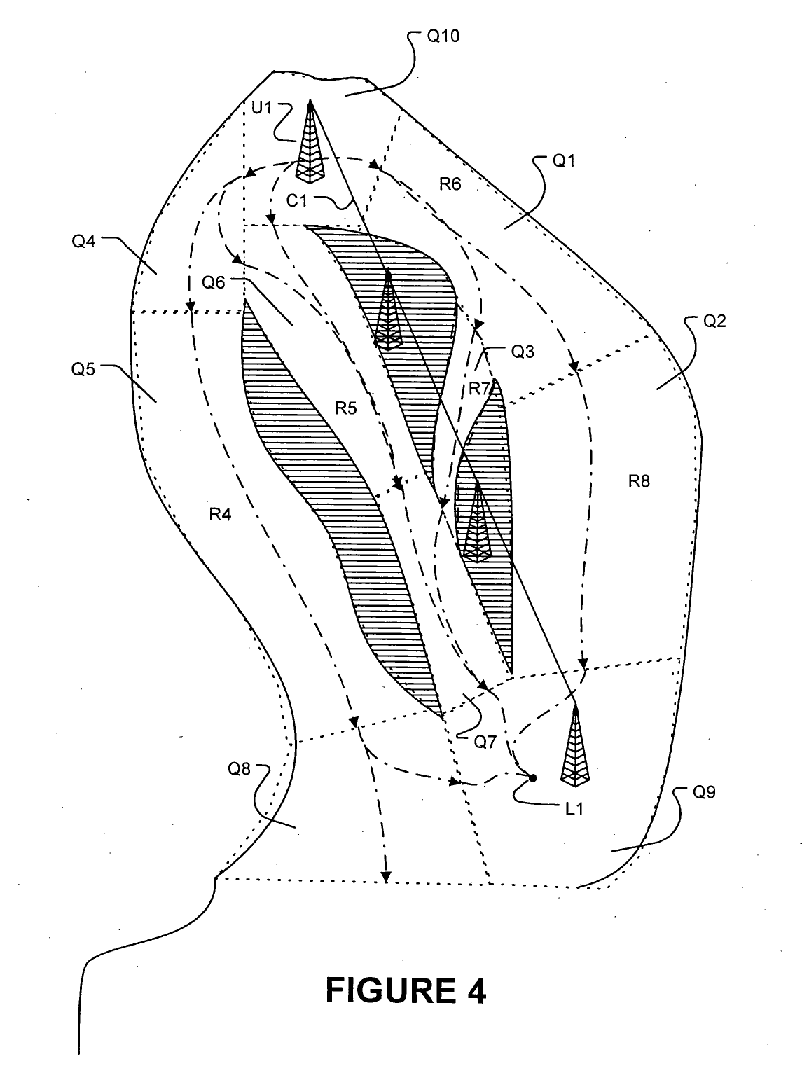

FIG. 4 illustrates an example section of a ski area. This section of the ski area has runs R4, R5, R6, R7 and R8. A chairlift C1 extends from a loading station L1 to an unloading station U1. In a GIS database are defined a number of polygons Q1 to Q10. The polygons are laid out so that when a skier is on a ski run, the skier is also in a polygon (which may be one of several) associated with that ski run. In this case, identifying a polygon in which a portable unit 12 is located also identifies a run on which the portable unit 12 is located. Some runs have multiple polygons. Each polygon abuts one or more other polygons from which the polygon can be entered or exited. For example, in the ski hill and arrangement of polygons shown in FIG. 4, a skier could enter polygon Q1 from polygon Q10. A skier could exit polygon Q1 into either polygon Q2 or polygon Q3.

Polygons do not necessarily correspond only to groomed ski runs. For example, there sometimes exist ski routes which pass through treed areas between main ski runs. In such cases a polygon may be assigned to the treed area. The polygons from which the treed area can be entered and the polygons from which the treed area can be exited may be identified. Even if heavy tree coverage prevents GPS unit 14 from determining a location while the skier is in the treed area, the route determining algorithms described herein may be used to determine that a skier has most likely passed through the treed area.

Each polygon is associated with one or more line segments which represent a typical central fall line along which a skier might ski through the polygon from an entrance point to an exit point. Each line segment may be termed a run segment. Run segments of adjacent polygons can be joined to define a path taken by a skier along a ski run, or sequence of ski runs, as a single line. The line segments connect points where two ski runs or two parts of the same ski run meet. The line segments form a network which represents the network of ski runs and can be used to model the paths of the skiers. This network can be represented in the form of a route table.

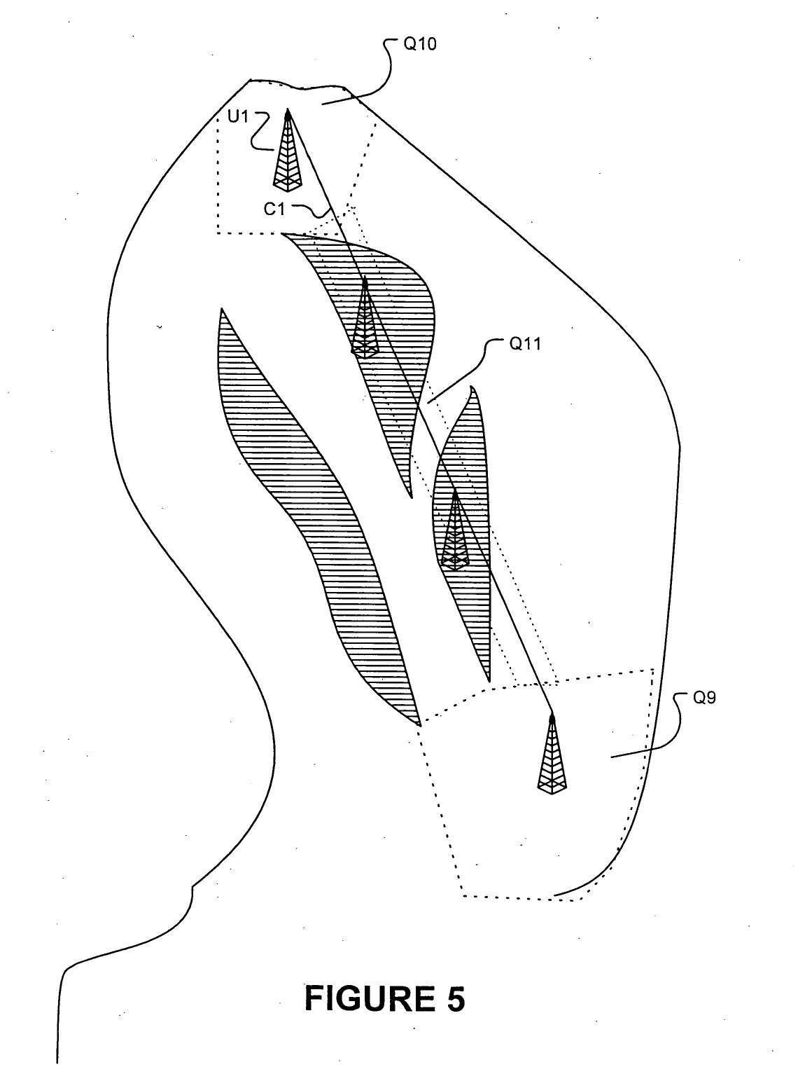

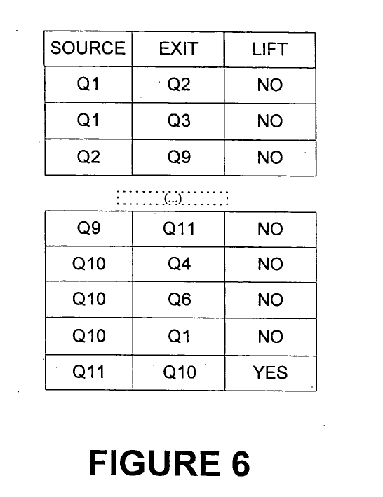

A route table may comprise two fields, “source” and “exit”. The “source” field contains information identifying a polygon that a skier may be coming from, the “exit” field contains information identifying the polygon(s) the skier can ski into from the source polygon. The route table includes a record for every exit option of every possible source polygon. The source-exit relationships in the route table build in a direction of movement. There is a basic assumption that the skier is always skiing downhill as reflected by the “source” and “exit” relationships stored in this table. An exception to this rule is when the exit polygon represents a ski lift that goes uphill. A partial routing table based upon the area of FIGS. 4 and 5 is shown in FIG. 6.

The path taken by a skier through the ski area can be represented by a path table. A path table can be built from the location information transmitted by portable unit 12. The path table can be built by comparing the location data for a skier to the run polygon data, one point at a time. In this manner, system 10 can identify the polygon in which the user is located. This “point in polygon” process is a standard GIS function available in at least most commercially available GIS systems. This process returns a list of polygon IDs that correspond to the skier's known GPS locations. The polygon IDs are stored in a path table for the skier. The sequence in which the skier was located in the polygons identified in the path table is known from the order in which the location information was taken. When several sequential point locations are contained within the same polygon, the ID of the polygon needs be stored in the skier's path table only once.

Initially the first and second known polygon IDs from the path table are processed. This process involves finding a first set of records in the route table for which the ID of the first polygon is a “source”. Each of the records of the first set is checked to see if its “exit” field contains the ID of the second polygon. If so the system determines that the skier skied directly from the first polygon to the second polygon. Processing then continues by taking the second and third polygons from the source table.

If the second polygon ID is not found in the “exit” field of any of the records of the first set then the process identifies possible paths that the skier might have taken to get from the first polygon to the second polygon. This can be done by retrieving as a second set those records for which the “source” field contains polygon IDs corresponding to IDs in the “exit” field of any of the first set of records. The polygon IDs in the “exit” fields of the second set of records can be checked for a match to the second polygon. This process is run till the polygon ID of the second polygon matches the polygon ID of an “exit” field in the route table. This process can be iterated until one or more possible routes from the first polygon to the second polygon have been identified.

If the process identifies multiple possible routes between the first polygon and the second polygon then the most likely one of those routes can be identified as described above. Once this is achieved the sequence of “source” and “exit” polygon IDs are saved and represent the path of the skier between two known points.

Ski lifts can be handled in various ways. Since ski lifts may pass over ski runs, it is not always possible to determine from one point of location information whether a skier is riding up on a ski lift or is skiing on a run below the ski lift. One way to include ski lifts as possible paths is to assign to each ski lift a buffered polygon large enough to capture all GPS point locations generated while the skier rides the ski lift. Ski lift polygons are included as exit and source polygons in the route table. The ski lift polygons may be kept in a separate area of the GIS system or otherwise segregated from other polygons. When a “source” polygon has an exit polygon which is a ski lift, that polygon can be checked first (since a typical behavior pattern of skiers reaching the bottom of a ski lift is for the skiers to get on the ski lift to ride back up). FIG. 5 shows a polygon Q11 corresponding to upward-going lift C1. In FIG. 5 other polygons have been removed for clarity.

As a backup to finding the GPS point within a ski lift polygon and the “source” and “exit” relationship, GPS elevation data measured by GPS 14, or a digital elevation model, or both, at multiple instances may be used to determine that a skier is both within the area of a polygon corresponding to a ski lift and is traveling upward.

In some embodiments of the invention, each location point is compared to the set of ski lift polygons to determine whether it lies within a ski-lift polygon. If so, the skier's elevation is checked to see if the skier is ascending. If so, the skier can be considered to be on the ski lift. Since ski lift rides typically last for a few minutes, system 10 will typically receive several data points while a skier rides a ski lift.

It can also be desirable to determine when a skier is “downloading” on a chairlift as opposed to skiing downhill. System 10 can determine that a skier is downloading by confirming that several sequential GPS locations are within a ski lift polygon (e.g. polygon Q11) and have decreasing elevation. In some embodiments, ski lifts that permit skiers to download are designated as download lifts. In such embodiments, system 10 may determine that a skier is downloading on a lift if several sequential GPS locations are within a ski lift polygon and the ski lift is designated as a download lift. The designation may comprise a suitable flag in a record corresponding to the lift and available to system 10.

Once all the polygons are selected that represent the skier's path the matching run segments are stored in the skie's path table.

The path of a skier can also be determined by way of a network tracing algorithm. In embodiments of the invention which use a network tracing algorithm, the sequence of a skier's known GPS point locations is run through a spatial comparison function to determine the ski runs traversed by the skier (e.g. by identifying ski run polygon IDs). The ski run polygon IDs may be related to corresponding run line segments via a database relationship. The vertices of the first two run segments may be used as the start and end trace points.

Examples of suitable spatial comparison functions include “point in polygon” functions. In embodiments that include lines representing or associated with ski runs the spatial comparison functions may include functions which locate one of the lines that is closest to a point.

The network tracing algorithm uses the direction of the run line segments to identify one or more sets of run line segments that correspond to possible paths taken by a skier. A network tracing algorithm can also use the status of runs, such as whether certain runs are closed, to influence the run segments selected to represent the skier's path. Also the difficulty of skiing through possible run line segments can be compared to the skier's skiing ability level (as stored in a skier profile) to determine the likelihood that a skier may have taken a particular run line segment. For example, expert runs would not likely be taken by a beginner skier.

Tracing algorithms are available in commercial GIS software and are based on the using the topological connectivity of the linear run segments. Once the shortest path is determined the selected run segments are stored to represent the skier's path.

In some embodiments of the invention, data points received from portable units 12 are subjected to reliability tests. In some embodiments, points which do not satisfy the reliability tests are discarded. Some examples of reliability tests that may be applied are:
The data point indicates that a portable unit is in a buffer area within which there is an ambiguity regarding the skier's actual location. For example, as discussed below, buffer areas may be provided covering locations close to where two chairlifts cross one another. When a skier is located in such a buffer area it may not be clear which lift the skier is on.
When compared to previous reliable data points, the data point indicates that the skier is traveling at an unrealistic speed.
The data point includes speed information that is unrealistic.
The data point indicates that the GPS signal on which the location specified by the data point is based is poor, either on an absolute scale or as compared to other data points.
Combinations of the above.

For example, upon receiving a data point specifying a skier's location, system 10 may evaluate the quality of the original location data by computing the distance between the skier's current location and the skier's most recent previous location. System 10 may compute a measure of the skier's speed by comparing the computed distance to the time since the skier was in the previous location. If the speed of the skier is realistic e.g. is within a range of, for example, 0-40 miles per hour (0-60 km/hr) then the new location is acceptable. If system 10 computes a speed outside of the realistic range (e.g. a speed of 100 miles per hour) then the new location may be ignored. In the alternative, portable devices 12 may compute average speed or maximum speed over some time interval locally and transmit the result to server computer 24, possibly together with a value of uncertainty for the calculated location and/or speed. If the speed value and/or uncertainty value(s) supplied by portable device 12 indicate that the location information supplied by portable device 12 may be of poor quality then server computer 24 may ignore that data point.

As another example, system 10 may be configured to ignore a data point in a case where system 10 detects a sudden drop in the quality of the location data provided by portable unit 12. Portable unit 12 may transmit the number of GPS satellites used to determine a location. If the number of satellites drops significantly in a short period of time (e.g. in under 5 minutes) to a number below a threshold value then the location information being provided by portable unit 12 may be unreliable.

Reliability information may be combined with information about the general area in which the skier is located to determine whether or not to treat a data point as being unreliable, for example by ignoring that data point. For example, where a skier's immediately previous reliable location was within a polygon that is associated by system 10 as being near or in a building and where the potentially unreliable location data point indicates that the skier is not within that building polygon then there is a significant likelihood that the skier has entered or is standing close to the building, as a result of interference from the building, the skier's portable unit 12 has lost contact with some GPS satellites, in consequence, the location information being reported by the skier's portable unit 12 is unreliable. System 10 may ignore the potentially unreliable most recent location information. A polygon (or other area) associated with a building may extend for a significant distance around the building's immediate footprint.

A skier's path may be used by system 10 in various ways. For example, the run segments can be used to mark on a map the runs on which a skier has skied. The resulting map may be printed out on a printer 26 accessible to server 24 or prepared in electronic format and transmitted to an e-mail address corresponding to the skier.

Once the skier's path is identified and stored a table of the run segments in the skier's path can be used to display the runs skied by highlighting them on a map. Various map views may be used to display the runs skied. For example, a cartographically correct view of the ski resort (which may be oriented in a way common in ski trail maps with the base of the runs and lodge at the bottom of the trail map) may be printed. To display the runs skied, the run line segments are highlighted on top of the colored polygons that represent the runs.

The runs skied by a skier can also be displayed on an artist's representation of the ski area. This can be accomplished easily by providing in a GIS system a map representing the artist's representation of the ski area. The artist's map includes line segments corresponding to the run line segments discussed above. The artist's map can be printed with the line segments corresponding to the run line segments of the skier's path highlighted. The line segments for the artist's map may have ID codes which correspond to ID codes of the run line segments in the skier's path table according to a table or the like accessible to the GIS system.

System 10 may also use a skier's path to compile statistics for the skier. For example, such statistics may include a current total vertical elevation the skier has skied and the number of descents the skier has skied. The total vertical elevation may be based on accumulating the known elevation of each chair lift taken by the skier. The known chair lift rides will be based on the results of determining the skier's path via the routing table algorithm or networking tracing algorithm.

At some resorts there is a need for skiers to “download” due to the lack of snow on the lower runs of the ski resort, or if they are tired. The “download” lift will be identified in the skier's path and the resulting elevation loss will be subtracted from the total accumulated elevation. The total number of lift rides will also represent the total descents. Two expections to this rule apply when the skier “downloads” on a lift, this will not be considered as a descent and when the skier takes one lift immediately after another (which is often the case at large mountains where two lifts are required to reach the top).

Some embodiments of the invention use an alternative method to determine a vertical elevation a user has skied. The alternative method computes total vertical elevation skied using a time sequence of elevations of the user's positions. As noted above, a system according to the invention obtains a stream of position information for each user. In some embodiments, for example, the system obtains information about the user's location every few seconds, or every minute or so.

The user's elevation at each location may be determined in any suitable manner. For example:
a digital elevation model (DEM) may be used to determine an elevation corresponding to map coordinates of the user's location;
the portable unit 12 carried by the user may measure the user's elevation and transmit elevation information to the server;
or the like.

A method for determining vertical elevation skied takes the time sequence of elevation points and applies a series of logical tests. The logical tests compare data points to one another and/or to reference elevations of features within the ski area such as the bases of lifts and the like. Spatial tests may be implemented through use of functions provided by a GIS.

A method for determining vertical elevation skied may be performed multiple times per day at any suitable intervals. The method may be performed each time using all data that has been accumulated about a user's position since beginning data acquisition (for example since the beginning of a day). In the alternative, the method may be performed only using data accumulated since the method was performed most recently.

A series of logical tests according to one embodiment of the invention operates as follows:
1. For each data point, compare the user's elevation to the previous data point and determine whether the user is ascending or descending. If the elevation difference between a data point and the previous data point is less than a minimum threshold (e.g. 10 meters) ignore the data point (i.e. treat the data point as if it did not exist). Otherwise, store the results.
2. If test “1” indicates that the skier is ascending then identify the closest ski lift and determine whether the user is within a threshold distance of that ski lift.
3. If the user is determined to be ascending for a plurality of (e.g. two or more, or three or more) successive data points and test “2” indicates that the user could possibly be on a ski lift then the user can be assumed to be riding up on a ski lift. Use the reference elevation of the base of that lift to determine the amount of elevation previously descended before the user got onto that lift.
4. If test “1” indicates that the skier is descending then add the elevation lost since the previous data point to the accumulating value of total elevation descended. If the user was on a lift immediately previously, use the reference elevation of the top of that lift as a basis for measuring the elevation descended by the skier since the top of the lift.
5. If test “1” indicates that the user is descending and the user is within a threshold distance of the centerline of a lift (e.g. 15 meters) or the user is within a buffer area corresponding to a lift, then the user might be downloading on the lift. If this condition holds for a number (e.g. 5 or more) of consecutive data points and the lift is designated as a downloading lift then (once only) subtract the total elevation of the lift (i.e. the difference between the elevation at the top of the lift and the elevation at the bottom of the lift) from the user's total elevation descended.
6. To avoid confusion that may result in instances where ski lifts cross one another or are close to one another, the system may include buffer regions (such as polygons) that cover the areas where ski lifts intersect one another or are close to one another.

For example, where two lifts cross, a buffer polygon may extend 15 meters to either side of the centerline of each lift and 50 meters in either direction along both lifts from the point at which the lift centerlines cross. In such cases the buffer polygons will have “X” shapes. Where two lifts are close to one another for a portion of their lengths then a buffer polygon may cover the space between the lifts and extend to a suitable distance (such as 15 meters) on either side of the lifts in their portion where they are close together. “close together may, for example, be closer than 40 meters (or some other distance such that the accuracy of the GPS or other location-determining mechanism may be incapable of reliably determining which of the lifts a skier is on). Locations within the buffer polygons may be ignored for purposes of determining total elevation descended.

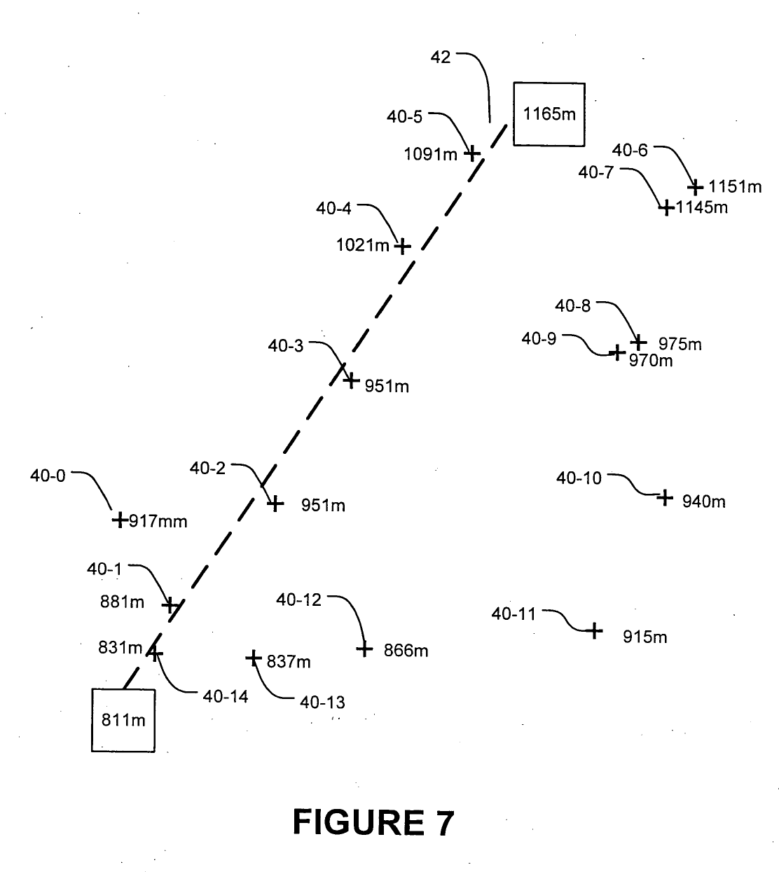

FIG. 7 illustrates the operation of the above rules in a simple case. FIG. 7 depicts a series of locations 40 occupied by a skier skiing on a ski hill. Each location is marked by a cross. Beside each location is marked a number indicating a sequence in which the location was detected and an elevation. So, for example, location 40-5 is the 5^{th} location detected and the elevation at location 40-5 is 1091 meters.

Applying the above logical tests to the sequence of data points illustrated in FIG. 7 results in the following decisions. For each of points 40-2 through 40-5, test “1” indicates that the user is ascending. After point 40-4 test “3” determines that the user is on ski lift 42. Test 3 therefore requires that 106 m (the elevation difference between point 40-0 and the reference elevation of 811 m at the base of lift 42) be added to the total elevation descended as of point 40-0. At point 40-6 test “1” indicates that the user is descending. According to test “4”, the system adds 14 m (the difference in elevation between the reference elevation of 1165 m at the top of lift 42 and the 1151 m elevation at point 40-6) to the user's total elevation descended. The system ignores point 40-7 because it is less than 10 meters below point 40-6 (according to test “1”). Similarly the system ignores point 40-9. For the other ones of points 40-6 to 40-13 the system applies test “4” and adds the elevation loss since the last point to the accumulated total elevation descended.

System 10 may also be configured to provide to a person carrying a portable unit 12 information that is specific to the person's current location. When the person requires information, the person can generate a request for information by way of user input 17 which could, for example, comprise a keyboard. The information request, which includes information specifying the person's current location as determined by GPS unit 14 is transmitted to server 24. At server 24, the request is processed. Depending upon the type of the request, processing the request may comprise retrieving information from a customer information database and/or a GIS database and returning the information to the user's portable unit 12 by way of wireless link 19. The returned information can be displayed on display 16.

System 10 may include a closest facility algorithm. The closest facility algorithm identifies the closest facility of a given type, such as a restroom, restaurant or the like to the skier's current location. This algorithm considers only facilities that are readily accessible by skiing down or taking a ski lift. For example a restroom only 100 feet away should not be considered to be “close” to the skier if it is up the hill. For the closest facility algorithm, the polygon in which the skier is currently located can be determined by applying the known GPS location with the “point in polygon” or other suitable spatial comparison function.

The closest facility algorithm can determine the closest facility of a type identified in a request from a user by determining paths from the polygon in which the user is currently located to various instances of the facility. In some embodiments, each polygon is associated with an ID code for a “supporting ski lift”. The Supporting ski lift ID identifies the closest ski lift base which is downhill from the polygon in which the skier is currently located. For each ski lift base the database stores the closest facilities of various types along with the distances of these facilities from the lift base.

After identifying the supporting ski lift base, the closest facility algorithm may calculate the distance between that lift base and the skier's location and then determine if another facility of the desired type is within that radius but at a lower elevation. If so then the closest facility algorithm compares the routing distance between the selected facilities. The routing distance may be determined based on the skier's paths required to reach each of the identified facilities and computing the total length of the run segment lines for each path and the distance of each facility from the corresponding ski lift base. System 10 then displays the facility which has the shortest routing distance from the skier on display 16.

If the path to a facility includes travel on a ski lift then the length of the path used for comparing the path to other paths may be increased depending upon the status of the lift. For example, if the lift has a heavy load and a long wait time then the closest facility algorithm may make the path to that facility longer so that another facility, which may be farther downhill may be identified as the closest facility of the type in question.

Some embodiments of the invention include a table which includes information identifying closest facilities of one or more types for each area in which a skier may be located. For example, a table of closest facilities may be associated with each polygon. The table of closest facilities may be a separate table or incorporated in another table. The polygon in which the skier is currently located can be determined, for example, by applying the known GPS location with the “point in polygon” function.

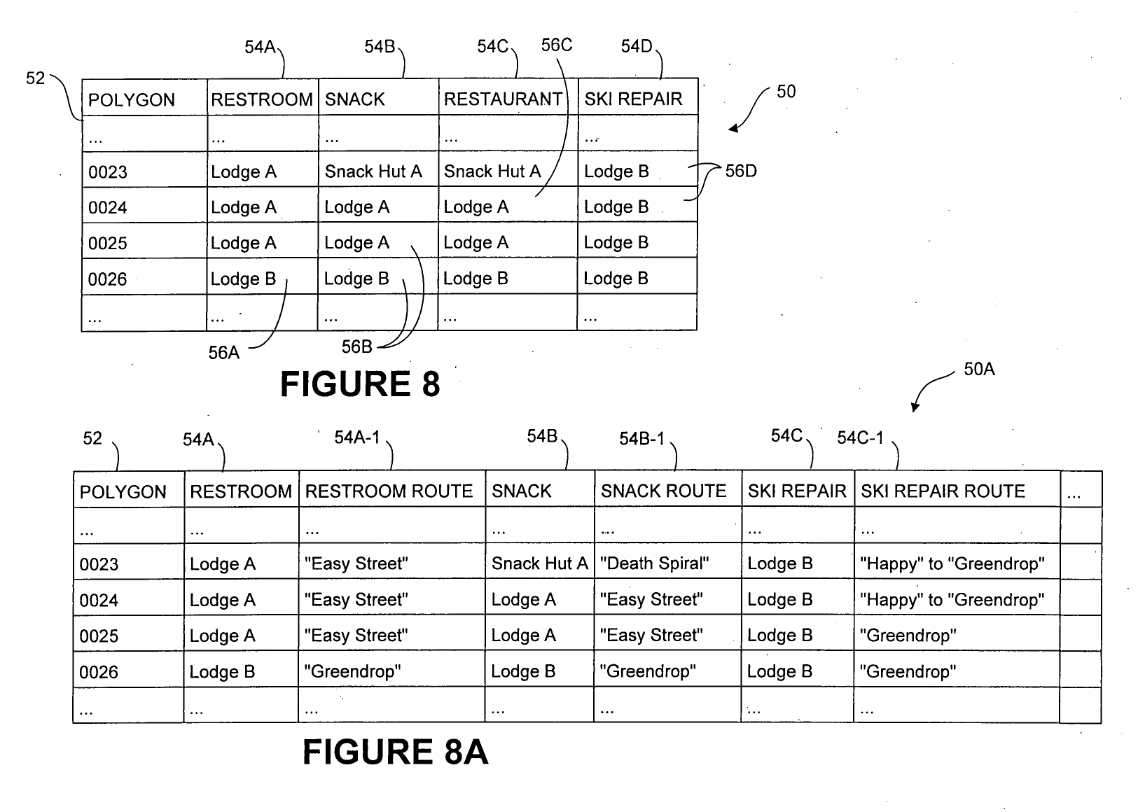

The closest facility table may include text that identifies the nearest facilities. An example closest facilities table 50 is shown in FIG. 8. Table 50 has a column 52 that includes a field identifying each polygon. Table 50 has columns 54A, 54B, 54C, 54D for various types of facility. In the illustrated embodiment, the fields 56A in column 54A contain text (or pointers to text) describing the location of the restrooms nearest the corresponding polygons; the fields 56B in column 54B contain text describing the locations of the snack bars nearest the corresponding polygons; the fields 56C in column 54C contain text describing the locations of the restaurants nearest the corresponding polygons; and, the fields 56D in column 54D contain text describing the locations of the ski repair facilities nearest the corresponding polygons. Other columns could be present for other kinds of facility.

The use of a table, as shown for example in FIG. 8, to identify nearest facilities is advantageous because it allows nearest facilities to be identified with less processing than in embodiments which use GIS algorithms to search for and identify nearest facilities. A table 50 can be populated manually with relatively little effort by a person who can determine by looking at a map which facilities are nearest to any given polygon. Since the facilities at most ski resorts are fairly static during the ski season, maintaining a table 50 is not typically onerous.

In some cases, whether a facility is the nearest facility to a given polygon will depend upon whether or not a specific ski lift is open. A system according to the invention may have two or more different tables 50. Which one of the tables 50 is active may be determined by which lifts are running and which lifts are not running. In some embodiments, separate tables 50 are provided for groups of polygons in different areas of a ski resort. This can simplify the structure of tables 50 in cases where the opening or closing of a ski lift in one area does not affect what facilities are nearest to polygons in another area.

In some embodiments of the invention, tables 50 include fields that identify one or more runs or lifts that can be used to reach the nearest facility. FIG. 8A shows a Table 50A which includes columns 54A-1, 54B-1, 54C-1, and 54D-1 which contain fields which respectively contain information describing runs or lifts to use to reach the closest facilities listed in the respective corresponding columns 54A, 54B, 54C, and 54D. These fields may contain text, or pointers to text, which can be transmitted for display on a portable unit 12.

A system which includes tables 50 (or other suitable data structures) which identify nearest facilities for polygons in a ski area may operate as follows:
Upon receiving a request for a nearest facility from a user, the system presents to the user a menu which allows the user to select a type of nearest facility. For example, the menu may list things like restrooms, telephones, first-aid facilities, ski repair facilities, snack bars, restaurants, bars, ski equipment stores, etc.
The user selects the type of facility that the user wishes to find.
The system identifies a polygon in which the user is located. This may be performed by comparing the user's location to a digital map layer of polygons. The system may receive information specifying the user's location specifically for use in finding a nearest facility or the system may use information about the user's location that it has on record.
The system looks up the requested information by searching table 50 for the row corresponding to the polygon in which the user is located and the column(s) corresponding to the type of facility of interest.
The system sends to the user's wireless device a text description of the location of the nearest facility and, optionally, a text or graphical depiction of the run or lift that can be taken to reach the nearest facility from the user's current location. The text description may use major landmarks to indicate where the nearest facility is located. For example, the text description may indicate that the closest restroom is located in “Glacier Lodge”, and can be reached by “Take Easy Glider Run”.

System 10 may have a function which permits a skier carrying a portable unit 12 to request the location of another skier. For example, friends or family members may use system 10 to find one another. System 10 may respond to such requests by providing the run and lift on which the other skier is currently located and displaying this information on display 16.

In some embodiments, server computer 24 maintains associations between groups of skiers who are authorized to find one another. For example, a group of friends may each obtain a portable unit 12. Server computer 24 may maintain an association between the friends. When a first one of the friends wants to find others the first friend invokes a “find friends” function from his or her portable device 12. Server 24 identifies the group of friends with which that portable device 12 is associated and returns a list of the other friends to the portable device 12. The first friend can then select from the list, for example by scrolling up or down, another friend that he or she wants to find. Server 24 will look up the present location of the portable unit 12 corresponding to the selected friend and return a description of the location to the portable unit 12 of the first friend. Preferably the location of the selected friend is provided in the form of readily understandable text such as “Mandy is at the bottom of the Stump Shredder chair” or “Franz is skiing down Upper Serenity run”.

In some embodiments of the invention, a user of a portable device 12 may have access to a search function whereby he or she can search for other skiers by entering text, speaking or spelling a name to a voice-recognition function or the like. Server computer 24 may produce a list of other skiers that have portable units 12 and match the search criteria supplied by the user. If the search locates more than one skier who matches the search criteria then the user of portable device 12 can select one, for example as described above.

In some cases it may be desired to provide users of system 10 with a desired level of privacy. Some users of system 10 may prefer that system 10 not provide their location to all or certain other users of system 10. Server computer 24 may include an authorization mechanism that controls who is able to use system 10 to locate any particular skier. The mechanism may, for example, be a simple mechanism that associates a number of portable units 12 together as a group and permits users of a portable unit 12 to find only other members of the group to which the portable unit 12 belongs. An association of a number of portable units 12 may be entered at the time a group of users register to use system 10, for example. The association may be stored in a database accessible to server computer 24. For example, a group of family members may request that server computer 24 permit the family members to find one another but not permit users of any other portable devices 12 from using system 10 to determine the whereabouts of the family members.

In more sophisticated embodiments, in response to receiving a request to find other skiers, server computer 24 checks for a list of other skiers that match the search information and have authorized the user of the portable device 12 to find them. For example, some skiers may permit their locations to be available to any other user of system 10 while other skiers may desire that their location be only made available to certain individuals or groups.

System 10 may be connected to a computer network, such as the Internet or a local area network, which may be wired or wireless. System 10 may be configured to permit authorized users of the computer network to access information about users of system 10. For example, search and rescue personnel could access system 10 to establish the locations of skiers in case of a weather emergency, the skiers are unaccounted for after closing time, or the like. Ski patrollers or other rescue personnel may have portable terminals that can be used to request and display information from system 10. System 10 may forward to such portable terminals maps showing the locations of users of system 10. As another example, a parent or other family member could monitor the locations of children, relatives or friends by accessing system 10 over the computer network.

As will be apparent to those skilled in the art in the light of the foregoing disclosure, many alterations and modifications are possible in the practice of this invention without departing from the spirit or scope thereof. For example, position-determining technologies other than GPS may be used to determine skier locations.

1. A skier information system comprising:
a server computer system connected to periodically receive location information for each of a plurality of portable devices carried by skiers at a ski resort to provide location data comprising a sequence of location points for each of the skiers;
the server computer system configured to determine that a first skier carrying a first one of the portable devices is ascending a ski lift when the location data for the first one of the portable devices indicates that the first one of the portable devices is within an area corresponding to the ski lift and the server computer determines that an elevation of the first portable device increases for a plurality of sequential location points within the area corresponding to the ski lift.

2. A skier information system according to claim 1 wherein the server computer system has access to an elevation gain corresponding to the ski lift, the server computer system maintains a record of total vertical elevation skied for the first skier and, upon determining that the first skier has ascended the ski lift, the first server computer increments the record of total vertical elevation skied by the first skier by the elevation gain corresponding to the ski lift.

3. A skier information system according to claim 2 wherein the ski lift is one of a plurality of ski lifts of the ski resort, the server computer has access to elevation gains corresponding to each of the plurality of ski lifts and, upon determining that the first skier has ascended any one of the ski lifts, the server computer is configured to increment the record of total vertical elevation skied by the first skier by the elevation gain corresponding to the one of the ski lifts ascended by the first skier.

4. A skier information system according to claim 3 wherein two or more of the plurality of ski lifts cross one another at a crossing point and the server computer is configured to ignore location points lying within a buffer region that includes the crossing point.

5. A skier information system according to claim 4 wherein the buffer region has arms extending away from the crossing point along each of the ski lifts.

6. A skier information system according to claim 3 wherein two or more of the plurality of ski lifts cross one another at a crossing point and the server computer is configured to ignore location points lying within a buffer region that includes the crossing point.

7. A skier information system according to claim 3 wherein a buffer region is located to cover an area wherein two or more of the plurality of ski lifts extend close to one another and the server computer is configured to ignore location points lying within the buffer region.

8. A skier information system according to claim 1 wherein the system comprises a digital elevation model associating locations in the ski resort with elevations and the server computer determines an elevation of a portable device by providing a location of the portable device to the digital model and receiving a corresponding elevation from the digital model.

9. A skier information system according to claim 1 wherein the first one of the portable devices comprises a data buffer and the first one of the portable devices is configured to store the location points in the data buffer at least when communication with the server computer system is interrupted and to transmit a plurality of the location points to the server computer system upon communication between the first portable device and the server computer system being reestablished.

10. A skier information system according to claim 1 wherein the server computer system is configured to generate a set of paths taken by the first skier from the location data for the first skier.

11. A skier information system according to claim 10 wherein the server computer system comprises a printer and the server computer system is configured to print the set of paths on a map of the ski resort.

12. A skier information system according to claim 10 wherein the server computer system comprises a graphic depiction of at least a portion of the ski resort including a plurality of ski runs and the server computer is configured to superpose indicia corresponding to the set if paths on the graphic depiction.

13. A skier information system according to claim 10 wherein the server computer system comprises a geographical information system database which includes information defining the geographical extent of ski runs at the ski resort wherein the server computer system is configured to generate the set of paths for the first skier by comparing the location information for the first skier to the geographical information system database.

14. A skier information system according to claim 13 wherein the server computer system is configured to compare the location information for the first skier to the geographical information system database by applying a spatial comparison function of the geographical information system database to the location points of the location data corresponding to the first skier.

15. A skier information system according to claim 14 wherein the spatial comparison function comprises a point-in-polygon function.

16. A skier information system according to claim 13 wherein the server computer system comprises a plurality of rules and is configured to apply the rules to determine which of a plurality of possible ski runs were most likely taken by the first skier.

17. A skier information system according to claim 18 wherein each of a plurality of ski runs is defined by a plurality of polygons connected end-to-end.

18. A skier information system according to claim 17 wherein each of the plurality of polygons is associated with one or more run segments representing a line along which a skier might ski through the polygon from an entrance point to an exit point.

19. A skier information system according to claim 18 comprising a route table, the route table comprising a source field and an exit field corresponding to each of the plurality of polygons.

20. A skier information system according to claim 1 wherein the server computer system is configured to determine that a skier is downloading by detecting that several of the location points for the skier correspond to an area associated with a download ski lift that permits downloading and are of decreasing elevation.

21. A skier information system according to claim 20 wherein the server computer has access to an elevation spanned by the download ski lift and the server computer is configured to subtract the elevation spanned by the download ski lift from the record of total vertical elevation skied by the first skier upon determining that the first skier has downloaded on the download ski lift.

22. A skier information system according to claim 1 wherein the server computer system is configured to determine a speed value associated with a skier's speed by comparing sequential ones of the location points and the server computer system is configured to ignore ones of the location points which result in the speed value being greater than a threshold speed.

23. A skier information system according to claim 1 wherein the server computer system is configured to receive speed values from the portable devices and the server computer system is configured to ignore ones of the location points which correspond to speed values that are greater than a threshold speed.

24. A skier information system according to claim 2 wherein the server computer system is configured to maintain the record of total vertical elevation skied by the first skier by applying a series of logical tests to the location points, the logical tests comprising:
a) for each data point, comparing the first skier's elevation to a previous data point and determining whether the first skier is ascending or descending; if the elevation difference between a data point and the previous data point is less than a minimum threshold ignore the data point; otherwise store the data point;
b) if test “a” indicates that the first skier is ascending then identify the closest ski lift and determine whether the first skier is within a threshold distance of that ski lift;
c) if the first skier is determined to be ascending for two or more successive data points and test “b” indicates that the first skier is within a threshold distance of the ski lift then use a stored reference elevation of a base of the ski lift to determine an amount of elevation previously descended before the user got onto the ski lift and add the amount of elevation previously descended to the record of total vertical elevation skied by the first skier;
d) if test “a” indicates that the first skier is descending then add the elevation lost since the previous data point to the record of total vertical elevation skied by the first skier; if the first skier was on a lift immediately previously, use a stored reference elevation of a top of the lift as a basis for measuring the elevation descended by the first skier since the top of the lift;
e) if test “a” indicates that the first skier is descending and the first skier is within a threshold distance of the centerline of a lift for a number of consecutive data points and the lift is designated as a downloading lift then subtract a total elevation of the lift from the record of total vertical elevation skied by the first skier.

25. A skier information system according to claim 1 comprising a closest facilities table which includes information identifying closest facilities of one or more types for each area within the ski resort in which a skier may be located.

26. A skier information system according to claim 25 comprising a geographical information system database which includes information defining polygons that collectively define the geographical extent of ski runs at the ski resort wherein the server computer system is comprises a closest facilities table associated with each of the polygons.

27. A skier information system according to claim 26 wherein the closest facilities tables include text that describes how to reach nearest facilities described in the nearest facilities table.

28. A skier information system according to claim 26 comprising a plurality of different closest facilities tables each corresponding to an operational status of lifts at the ski resort wherein the server computer system is configured to use one of the plurality of different closest facilities tables corresponding to a current operational status of lifts at the ski resort.

29. A skier information system according to claim 1 wherein the server computer system has access to associations between groups of skiers who are authorized to find one another.

30. A skier information system according to claim 1 wherein the server computer system computes statistics for the first skier and is configured to forward the statistics to the portable device carried by the first skier for display at the portable device.
